(19) United States
(12) Patent Application Publication
(10) Pub. No.: US 2014/0352211 A1
(43) Pub. Date: Dec. 4, 2014

(54) Luminaire System, Method, and Apparatus for Optimizing Plant Growth in a Controlled Farming Environment Technological Field

(71) Applicant: Matthew LIOTTA, Atlanta, GA (US)

(72) Inventor: Matthew Liotta, Atlanta, GA (US)

(21) Appl. No.: 14/365,600

(22) PCT Filed: Oct. 12, 2012
(86) PCT No.: PCT/US2012/059933

§ 371 Date: Jun. 13, 2014

Related U.S. Application Data
(60) Provisional application No. 61/569,901, filed on Dec. 13, 2011.

(51) Int. Cl. A01G 7/04; H05B 37/02

(52) U.S. Cl. CPC A01G 7/045; H05B 37/0245
USPC 47/58.1 LS; 315/76

(57) ABSTRACT

A luminaire system, apparatus, and method of using thereof, is disclosed for optimizing plant growth in a controlled farming environment. Different types of plants have different light requirements, and different inputs to controlled farming environment have different costs. For example, there may be certain times of day where, if power is not used, a cost savings is realized. Thus, the present invention provides a luminaire system for these controlled farming environments that receives light requirement information for the different types of plants, and in turn, adjusts the luminaire light source (110) via a luminaire light interface (106) to based on the light requirement information. The light requirement information may include spectrum in formation for the type of spectrum required or needed by the plants, power cost or savings information, or light quantity information representing the maximum amount of light to be provided to the plants in the controlled environment.

Embodiments of the present invention relate generally to farming techniques and, more particularly, to a luminaire system, method, and apparatus for optimizing plant growth in a controlled farming environment, including without limitation, a hydroponics system.

### BACKGROUND

In years past, farmers were completely dependent on nature for supplying the needs of their crops. The main needs of any plant are water and sunlight. Plants also require certain nutrients, which may receive from the soil via the plants roots. Farmers relied on rain for water, on the sun for light, and on the nutrients in the soil for the crops' nutritional needs. While farmers looking to nature to provide these resources are spared the costs of providing the resources artificially, these farmers face a tremendous uncertainty each year due to the unpredictable temperament of nature.

As farming has progressed, farmers have become less dependent on nature for meeting all of these biological needs, and hence, have lessened the impact such nature-related uncertainty has on their livelihoods. With the advent of artificial irrigation, farmers began to control the amount of water received by their crops rather than relying completely on rain. With fertilizer, farmers could increase the amount of nutrients in the soil. Lastly, with artificial light, farmers can provide the amount of light needed for photosynthesis regardless of the position of the sun.

While these man-made measures provide more predictability to modern farmers, each of these man-made measures come with a financial cost that have an effect on the farmer's bottom line. Thus, as modern farmers look to increase the efficiency of these controlled farming environments, conservation of resources has become a top priority, as well as maximizing the growth of the plants in these controlled environments with the least amount of resources. Therefore, as farming continues to move towards completely man-made environments, there is a need in the art for a system, method, and apparatus to optimize the utilization of resources, such as artificial light, in these controlled farming environments.

### SUMMARY

To address the needs and deficiencies described above, the various embodiments of the present invention provide for a luminaire system and method for optimizing plant growth and efficient use of artificial light resources in a controlled farming environment. Every type of plant has certain light requirements, wherein these light requirements include a specific light intensity, specific spectrum, and duration of light, to maximize plant growth. These requirements may not always mean “fastest” growth, as light can have psychological effects on plant growth. Plants have secondary metabolites that can be targeted or avoided using specific spectrum; e.g. with some plants, the color of the plant can be altered based upon the amount of UV light exposure to the plant. These light requirements are represented by light requirement information, and may be stored in an internal location or an external location (from the luminaire system) such as a farming environment database or a farming environment website. Once the luminaire obtains the light requirement information, the luminaire determines if adjustments should be made to a light source in the controlled farming environment to correspond to the light requirement information. The luminaire actuates any adjustments, and in one embodiment, updates information in a memory to reflect the current light provided to the plurality of plants in the controlled environment.

Therefore, one embodiment of the present invention provides an luminaire system for optimizing plant growth in a controlled environment, the luminaire system comprising: a controller, wherein said controller has a bidirectional communication link to the internet; a luminaire light source, wherein the luminaire light source is coupled to one or more luminaires; and, a light source interface providing a communication link from the luminaire light source and the luminaire controller. The luminaire controller is configured to receive light requirement information from a farming environment database, a farming environment website, or a third party website (or database) via the bidirectional communication link. The light requirement information may comprise spectrum information, or light quantity information, which may include a specific light measurement value in moles or the amount of light to be provided to a plant in a particular time measurement.

Another embodiment of the present invention provides a method of utilizing a luminaire system to optimize plant growth for a plurality of plants in a controlled environment, the method comprising: determining light requirement information for one or more plants; ascertaining current light level in the controlled environment; and adjusting the inputs to the controlled environment based on the light requirement information and current light level. The step of determining light requirement information may further comprise accessing a farming environment database, a farming environment website, or a third party website (or third party database) via a bi-directional communication link. The step of determining light requirement information may comprise receiving a light quantity requirement, light duration information, or spectrum information. The step of adjusting may comprise scheduling a light source to be inactive during certain times of the day or varying the spectrum and/or intensity of the light provided by the luminaire system in the controlled farming environment.

Yet another embodiment of the present invention provides for an apparatus for optimizing plant growth in a controlled environment, the apparatus comprising: a power source; at least one processor; and at least one memory including computer program code, the at least one memory and the computer program code configured to, with the at least one processor, cause the apparatus at least to: determine light requirement information for one or more plants; ascertain current light level in the controlled environment; and, adjust the inputs to the controlled environment based on the light requirement information and current light level.

The at least one memory and the computer program code may be further configured to, with the at least one processor, cause the apparatus to: i) access a farming environment database, farming environment website, or third party website (or database) via a bi-directional communication link; ii) in said determining step, receive a light quantity requirement or spectrum information; or iii) in said adjusting step, schedule a light source to be inactive during certain times of the day or vary the spectrum of the light provided by the luminaire light source in the controlled farming environment. The power source may comprise one or more renewable energy sources, and the luminaire light source may comprise, for example, an LED light source.

These and other embodiments will be described in greater detail in the detailed description of the various embodiments of the present invention, wherein those skilled in the art will appreciate that many deviations may be made while maintaining the spirit and scope of the present invention.

### BRIEF DESCRIPTION OF THE SEVERAL VIEWS OF THE DRAWINGS

Having thus described embodiments of the invention in general terms, reference will now be made to the accompanying drawings, which are not necessarily drawn to scale, and wherein:

FIG. 1 illustrates the luminaire system according to various embodiments of the present invention.

FIG. 2 further illustrates the luminaire system according to an embodiment of the present invention, wherein said luminaire system includes communication links to a farming environment website and farming environment database.

FIG. 3 illustrates the luminaire controller according to an embodiment of the present invention.

FIG. 4 is a flow diagram illustrating the steps of a method of adjusting the luminaire light source in the luminaire system in accordance with an embodiment of the present invention.

FIG. 5 is a flow diagram illustrating the steps of a method in accordance with a specific embodiment of the present invention for adjusting the spectrum of the luminaire light source in a controlled farming environment.

### DETAILED DESCRIPTION

The present invention now will be described more fully hereinafter with reference to the accompanying drawings, in which some, but not all embodiments of the inventions are shown. Indeed, these inventions may be embodied in many different forms and should not be construed as limited to the embodiments set forth herein; rather, these embodiments are provided so that this disclosure will satisfy applicable legal requirements. Like numbers refer to like elements throughout.

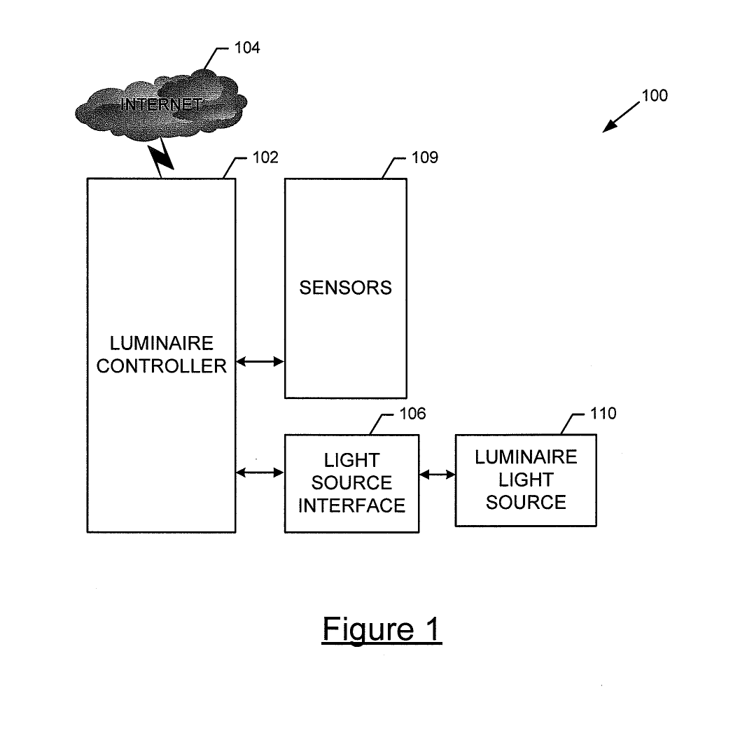

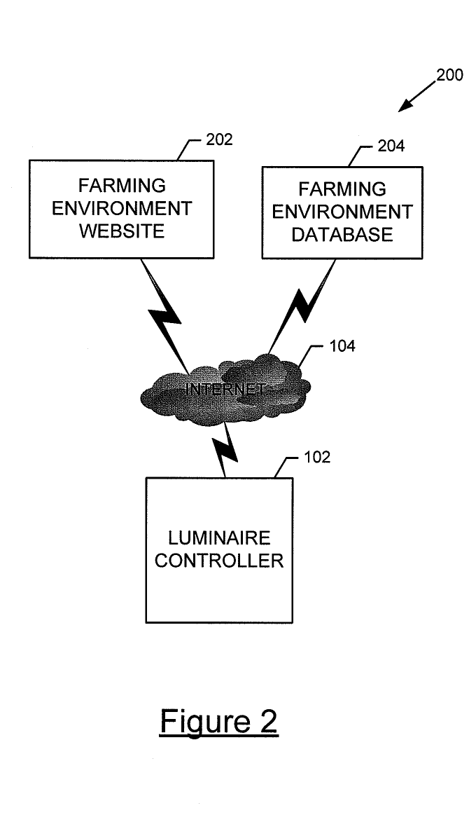

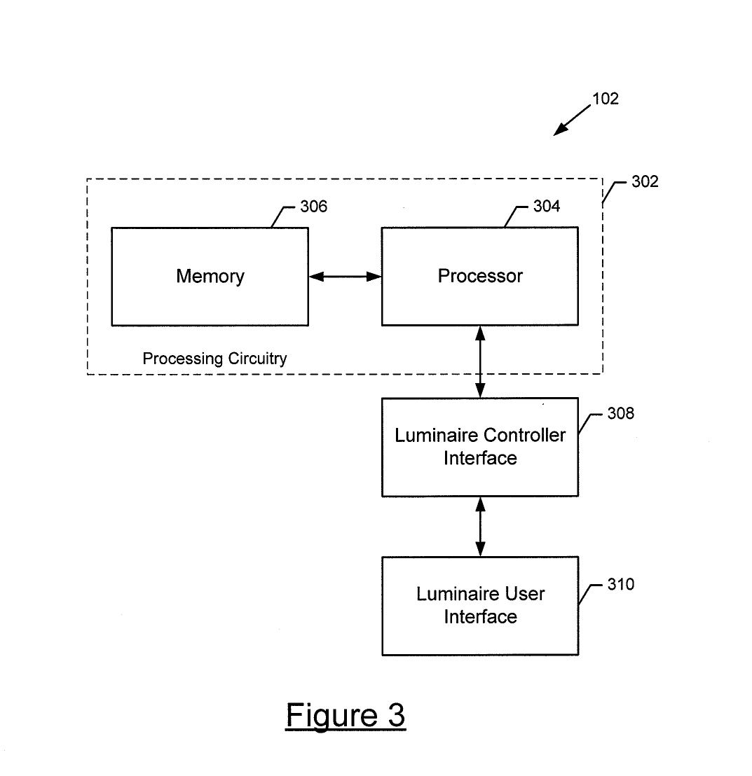

FIG. 1 illustrates a luminaire system 100 configured to optimize resources in a controlled farming environment according to various embodiments of the present invention. System 100 includes luminaire controller 102, which is described in detail in FIG. 3 below. Luminaire controller 102 is communicatively coupled via a bidirectional, or unidirectional, communication link to a local or wide area network, such as the internet 104. Via the bidirectional communication link with internet 104, the controller 102 may access one or more network locations, such as a farming environment website, farming environment database, or third party website to obtain light requirement information, as described in greater detail in FIG. 2.

System 100 further comprises a light source interface 106 and luminaire light source 110. The light source interface 106 is communicatively coupled to the luminaire light source 110, and in one embodiment, is configured to receive signals from controller 102 operative to either alter the spectrum provided by the luminaire light source, or alter the quantity of light provided to the plurality of plants in the controlled farming environment 100. The light source interface 106 may comprise any type of interface for receiving a signal from controller 102, or in other embodiments, may comprise a user interface for receiving input from a user, and in turn, controlling a luminaire light source 110.

The luminaire light source 110 may comprise any device or means for providing light in a controlled farming environment, including without limitation, a light emitting diode or a collection of light emitting diodes. However, it is not the intention of the present invention to limit the luminaire light source to a LED device. In fact, the luminaire light source may comprise any artificial light source that can have its intensity and spectrum altered via an electrical signal while maintaining the spirit and scope of the present invention.

Luminaire controller 102 may be communicatively coupled to one or more optical sensors 109, which may be configured to obtain any type of information required or needed by the various embodiments of the present invention. For example, and without limitation, sensors 109 may be configured to obtain the amount, type, duration, or spectrum of light received during a certain period of time, by one or more plants in the controlled farming environment (“current level information”). These sensors may comprise standard optical sensors, or sensors designed especially for use in the particular controlled farming environment. These sensors 109 may be further configured to, after obtaining current level information from the controlled farming environment, to store this information in a memory 306 as shown in FIG. 3 or any other computer-readable storage medium. In yet another embodiment of the present invention, these sensors 109 may also be configured to send this information to a computer terminal or smart phone device to elicit input from a user via a user interface.

FIG. 2 further illustrates the portion of the luminaire system involving network locations which may include the aforementioned light requirement information for the plants in the controlled environment 100 according to an embodiment of the present invention. As shown in system 200, the luminaire controller 102 may access, via a bidirectional (or unidirectional) connection with internet 104, one or more network locations. These network locations may comprise, as shown in FIG. 2, a farming environment website 202 which may publish light requirement information for one or more types of plants. As another example, a network location may comprise a farming environment database 204 which may store light requirement information in a computer memory or other computer readable medium. This farming environment database 204 may comprise, without limitation, a database data collection utilized with a database management system (DBMS) to comprise a database system or a computer readable memory located inside a computer terminal. Those skilled in the art will appreciate that a number of other network locations may be accessed by controller 102 to obtain light requirement information, in addition to or instead of, the farming environment website 202 or farming environment database 204 within the spirit and scope of the present invention, for example and without limitation, a third party website or third party database.

FIG. 3 illustrates the luminaire controller 102 of the luminaire system 100 in greater detail according to an embodiment of the present invention. As shown in FIG. 3, the luminaire controller 102 may include or otherwise be in communication with processing circuitry 302 that is configurable to perform actions in accordance with example embodiments described herein. The processing circuitry 302 may be configured to communicate signals to the light source interface 106, perform data processing, and receive signals from optical sensors 109, as well as application execution and/or other processing and management services according to the various embodiments of the present invention. The data processing function may comprise analysis of current level information received from optical sensors 109, along with a comparison of that current level information with light requirement information, to determine an adjustment decision for the controlled environment, such as a signal to the luminaire system 100 to only emit light in a certain spectrum or power the luminaire light source 110 during certain time periods but in a sufficient amount to meet the nutritional requirements for the plurality of plants.

In some embodiments, the luminaire controller 102 or the processing circuitry 302 may be embodied as a chip or chip set. In other words, the luminaire controller 102 or the processing circuitry 302 may comprise one or more physical packages (e.g., chips) including materials, components and/or wires on a structural assembly (e.g., a baseboard). The structural assembly may provide physical strength, conservation of size, and/or limitation of electrical interaction for component circuitry included thereon. The luminaire controller 102 or the processing circuitry 302 may therefore, in some cases, be configured to implement an embodiment of the present invention on a single chip or as a single “system on a chip.” As such, in some cases, a chip or chipset may constitute means for performing one or more operations for providing the functionalities described herein.

In an example embodiment, the processing circuitry 302 may include a processor 304 and memory 306 that may be in communication with or otherwise control a luminaire controller interface 308. As such, the processing circuitry 302 may be embodied as a circuit chip (e.g., an integrated circuit chip) configured (e.g., with hardware, software or a combination of hardware and software) to perform operations described herein in relation to the controlled farming environment. The luminaire controller interface 308 may include one or more interface mechanisms for enabling communication with other devices, such as the luminaire user interface 310, sensors 109, a farming environment database or website, and/or networks, such as Internet network 104. In some cases, these interface mechanisms may be any means such as a device or circuitry embodied in either hardware, or a combination of hardware and software that is configured to receive and/or transmit data from/to a network and/or any other device or module in communication with the processing circuitry 22. In this regard, the controller interface may include, for example, an antenna (or multiple antennas) and supporting hardware and/or software for enabling communications with a wireless communication network.

The processing circuitry 22 and the luminaire controller interface may be configured to detect a change in light requirement information, and generate a signal to effectuate a change in the controlled farming environment based on the change in light requirement information. Thus, if there is a change in the light requirement information stored at a network location, the change in light requirement information may be detected by the luminaire controller interface. In response, the processing circuitry may generate a signal to response depending on the particular type of change in light requirement information. If the change in light requirement information comprises a cost savings if the luminaire light source 110 is active only at a certain time of the day, then the signal would comprise deactivating the luminaire light source 110 during the peak time period, and activating the luminaire light source 110 during the reduced rate time period. If the change in light requirement information included some other type of information, such as a change in spectrum required for the plants, then the luminaire controller interface would generate a signal in response to the change in light requirement information to alter the spectrum of the light provided to the plants in the controlled environment. Those skilled in the art will appreciate that any number of changes in light requirement information could be handled by the various embodiments of the present invention.

Referring again to the details of the luminaire controller 102, in an example embodiment, the memory 306 may include one or more non-transitory memory devices such as, for example, volatile and/or non-volatile memory that may be either fixed or removable (including without limitation flash EEPROM memory). The memory 306 may be configured to store information (such as, without limitation, light requirement information for a plurality of plants in accordance with several example embodiments of the present invention), data, applications, instructions or the like for enabling the controller 102 to carry out various functions in accordance with example embodiments of the present invention.

For example, the memory could be configured to buffer input data, such as light requirement information or current level information, for processing by the processor 304. Additionally or alternatively, the memory could be configured to store instructions for execution by the processor. Among the contents of the memory, applications may be stored for execution by the processor in order to carry out the functionality associated with each respective application. In some cases, the memory may be in communication with the processor via a bus for passing information among components of the apparatus, for example and without limitation, current level information or light requirement information.

The processor 304 may be embodied in a number of different ways. For example, the processor may be embodied as various processing means such as one or more of a microprocessor or other processing element, a coprocessor, a controller or various other computing or processing devices including integrated circuits such as, for example, an ASIC (application specific integrated circuit), an FPGA (field programmable gate array), or the like. In an example embodiment, the processor may be configured to execute instructions stored in the memory 306 or otherwise accessible to the processor. As such, whether configured by hardware or by a combination of hardware and software, the processor may represent an entity (e.g., physically embodied in circuitry—in the form of processing circuitry 22) capable of performing operations according to embodiments of the present invention while configured accordingly. Thus, for example, when the processor is embodied as an ASIC, FPGA or the like, the processor may be specifically configured hardware for conducting the operations described herein. Alternatively, as another example, when the processor is embodied as an executor of software instructions, the instructions may specifically configure the processor to perform the operations described herein.

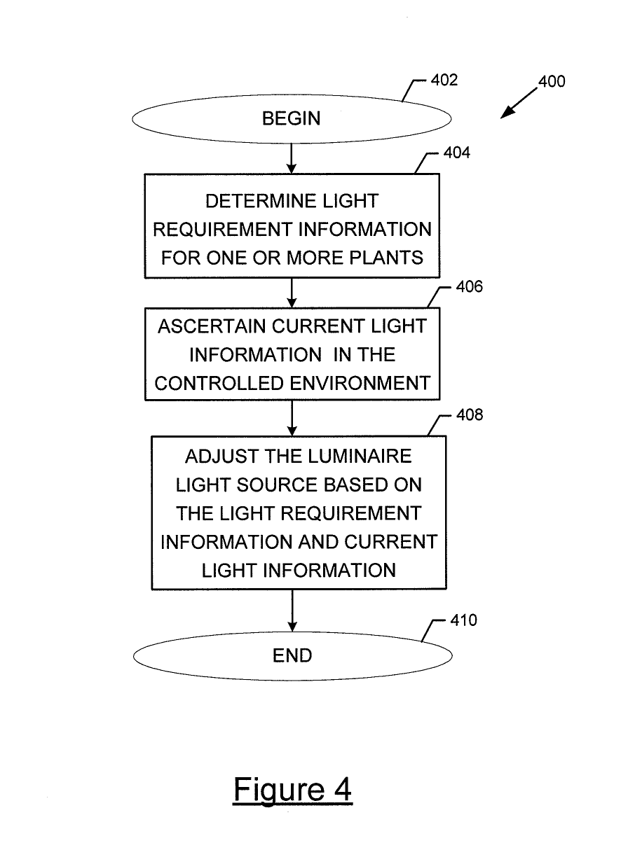

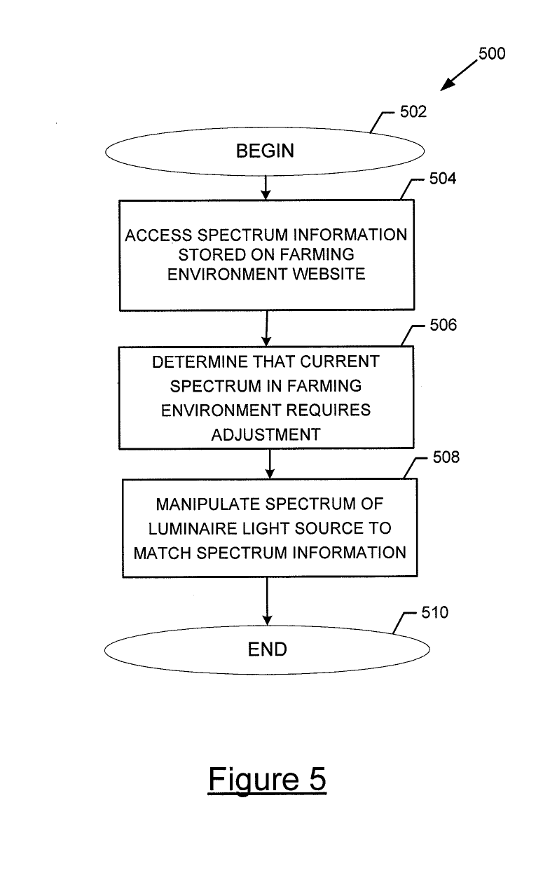

While example embodiments of the present invention have been described above in conjunction with FIGS. 1-3, a flowchart of the operations performed from the perspective of a user is now provided with reference to FIGS. 4-5. It will be understood that each block of the flowcharts, and combinations of blocks in the flowcharts, may be implemented by a user comprising various means, such as hardware, firmware, processor, circuitry, and/or other device associated with execution of software including one or more computer program instructions. For example, one or more of the procedures shown by the flowcharts may be embodied by computer program instructions. In this regard, the computer program instructions which embody the procedures depicted by the flowcharts may be stored by a memory device of an apparatus employing an embodiment of the present invention and executed by a processor in the apparatus.

As will be appreciated, any such computer program instructions may be loaded onto a computer or other programmable apparatus (e.g., hardware) to produce a machine, such that the resulting computer or other programmable apparatus provides for implementation of the functions specified in the flowchart block(s). These computer program instructions may also be stored in a non-transitory computer-readable storage memory that may direct a computer or other programmable apparatus to function in a particular manner, such that the instructions stored in the computer-readable storage memory produce an article of manufacture, the execution of which implements the function specified in the flowchart block(s). The computer program instructions may also be loaded onto a computer or other programmable apparatus to cause a series of operations to be performed on the computer or other programmable apparatus to produce a computer-implemented process such that the instructions which execute on the computer or other programmable apparatus provide operations for implementing the functions specified in the flowchart blocks.

Accordingly, blocks of the flowcharts support combinations of means for performing the specified functions and combinations of operations for performing the specified functions. It will also be understood that one or more blocks of the flowcharts, and combinations of blocks in the flowcharts, can be implemented by special-purpose hardware-based computer systems which perform the specified functions, or combinations of special purpose hardware and computer instructions.

FIG. 4 is a flow diagram illustrating the steps of a method of adjusting the luminaire light source in the luminaire system in accordance with an embodiment of the present invention. Method 400 begins at step 402 and proceeds to determine light requirement information for one or more plants at step 404. Determining light requirement information may comprise any number of methods or processes to obtain data regarding the light needs of the plurality of plants. For example and without limitation, and as mentioned previously, determining light requirement information may comprise accessing a farming environment database, a farming environment website, a third party website, or a third party database. The light requirement information for each plant in the controlled environment may be stored in a database file, a computer file such as a Microsoft Excel file, or an internet location accessible via a bi-directional or uni-directional communication link. As another example, the light requirement information may be input from a user, beforehand or in real-time, via a user interface.

This light requirement information, in any example, comprises numerical values representing spectrum values or quantities of light needed by the plurality of plants. Lettuce, for example, requires 17 moles of light a day for optimum growth under ambient co2 levels. Any less, or more, light in a 24 hour period will result in either slowed, or improperly accelerated, growth of the lettuce. However, at higher concentrations of co2, such as 1600 ppm, lettuce would only require 11 moles of light a day. Thus, the nutritional information may comprise the amount of light required, in moles as specific co2 levels, which would correspond to a certain amount of hours of light a needed a day to the plants for optimum growth. Other examples of information that may be included in light requirement information may comprise duration of light required, or light intensity. In fact, the light requirement information may comprise a “recipe” including any and all of these information types. For example, light requirement information may comprise spectrum information, intensity information, and light duration information (in numbers of hours or other time quantifier). Those skilled in the art will appreciate that other values, quantities, and types of data may be included in the light requirement information within the spirit and scope of the present invention.

At step 406, method 400 ascertains the current levels of light being provided to the plurality of plants in the controlled environment. To ascertain the current levels, the various embodiments of the present invention may utilize any number of optical sensors or other information gathering devices to obtain information regarding the current levels of light in the controlled environment. Further, this information gathered (and included within current level information) may include, without limitation, the spectrum of light being provided to the plants in the controlled environment, the amount/duration of light being provided to the plants in the controlled environment, or any other information relevant to the light requirement information.

At step 408, method 400 adjusts the luminaire light source 110 included in the luminaire system 100 in the controlled environment based on a comparison between the light requirement information and the current level information. This adjusting step involves the present invention analyzing light requirement information from step 408, and considering the current level information with the light requirement information, and making any adjustments to the luminaire light source 110 (or scheduling any adjustments to luminaire light source 110) that would optimize plant growth and/or decrease costs incurred in operating the controlled environment.

For example and without limitation, if the plurality of plants comprises lettuce, and in step 404, method 400 determines that the luminaire is provided 18 moles of light a day to the plurality of plants, in order to provide the 17 moles to the lettuce, the present invention can, via the controller, instruct the electrical interface to power the light source only until 17 moles of light are delivered to the plurality of plants. As another example, without limitation, the adjusting step may comprise adjusting the spectrum of light provided to the plurality of plants in the controlled environment via the luminaire light source 110 to correspond with a preferred spectrum included in the light requirement information. Those skilled in the art will appreciate that any number of adjustments may be made as part of this step 408 within the spirit and scope of the present invention.

Method 400 terminates at step 410.

As referenced above, FIG. 5 is a flow diagram illustrating the steps of a method in accordance with a specific embodiment of the present invention relating to adjustment of the luminaire light source based on spectrum information in the current level information in the controlled farming environment. Method 500 begins at step 502, and proceeds to obtain light requirement information via a farming environment website at step 504 (as shown in FIG. 2). As mentioned above, this light requirement information may include, without limitation, preferred light amounts and preferred spectrum information. The step of obtaining the light requirement information may happen any number of times or ways within the spirit and scope of the present invention. For example, the light requirement information may be obtained once, automatically at certain time periods, or upon user request received via a user interface.

At step 506, method 500 determines that the light requirement information for lettuce includes a preferred spectrum of light that, when provided to the lettuce, results in a yield of lettuce that are a preferred red color. At step 508, method 500 sends a signal to the electrical interface to alter the luminaire light source 110 to provide light in the preferred spectrum. Method 500 continues for so long as plants are raised in the controlled farming environment in accordance with the various embodiments of the present invention, and terminates at step 510.

As mentioned previously, the light requirement information may include any number of criteria, in a “recipe” of sorts, for optimizing plant growth. For example, light requirement information may include a combination of light spectrum information, light intensity information, or duration of light exposure (in hours or some other time quantifier). The optimum “recipe” comprising light requirement information is dynamic based on constraints, including without limitation, costs of power or CO2 levels. As the light requirement information is dynamic, the communication between the luminaire controller 102, and the location where the light requirement information is stored (whether stored in the farming environment database 204, the farming environment website 202, or other location) will occur at a certain frequency to ensure that the adjustments are effectuated in the controlled farming environment as necessary to realize the optimized environment.

Because the light requirement information is dynamic, changes will occur to the light requirement information during the growth of the plant. When the light requirement information changes, a process as shown in FIGS. 4-5 will occur if needed based on the current level information to match the current light requirement information. As another example, cost of power is one piece of information that can be included in light requirement information. If the cost of power is cheaper during the later part of the day, then the present invention would generate a signal to configure the luminaire light source to only be illuminated, or active, during the lower rate time period. Those skilled in the art will appreciate that numerous factors and possibilities may be present within the spirit and scope of the present invention.

Numerous other advantages are provided by the various embodiments of the present invention. By providing a system to farmers that intelligently provides light to plants in a controlled environment, farmers utilizing the present invention will experience significant cost savings by providing only the needed amount of light to their plants. Thus, the present invention provides a system, method, and apparatus by which these farmers growing plants in a controlled environment, such as hydroponics system, will see a direct increase to their bottom line. By increasing the profitability of such green techniques for growing plants, more farmers will be attracted to the industry, which will in turn have the effect of more local communities enjoying the benefits that can be gained from having local produce on their shelves rather than produce shipped from long distances. Furthermore, by including light spectrum information in with the light requirement information which can be dynamically changed, farmers can easily provide and care for plants with complex environment requirements (for example, plants requiring only a certain amount of light within a certain spectrum). Lastly, by controlling the amount of light provided via the present invention, the farmer can more easily provide top quality produce as the quality of many types of produce can deteriorate with too much light.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

That which is claimed:

1. A luminaire system for optimizing plant growth in a controlled environment, the luminaire comprising:
a luminaire controller, wherein said luminaire controller has a bidirectional communication link to a network location;
a luminaire light source, wherein the luminaire light source is coupled to one or more luminaries; and,
an electrical interface providing a communication link from the luminaire light source and the luminaire controller.

2. The luminaire system of claim 1, wherein the luminaire controller is configured to receive light requirement information from a network location via the bidirectional communication link.

3. The luminaire system of claim 2, wherein the network location may comprise a farming environment database.

4. The luminaire system of claim 2, wherein the memory location may comprise a farming environment website.

5. The luminaire system of claim 1, wherein the controller is configured to receive light requirement information from the network location via the bidirectional communication link.

6. The luminaire system of claim 1, wherein the light requirement information may comprise spectrum information.

7. The luminaire system of claim 1, wherein the light requirement information may comprise light quantity information which may include a specific light measurement value in moles.

8. The luminaire system of claim 1, wherein the luminaire controller is configured to detect a change in light requirement information, and generate a signal to effectuate a change in the controlled farming environment based on the change in light requirement information.

9. A method of utilizing a luminaire system to optimize plant growth for a plurality of plants in a controlled environment, the method comprising:
determining light requirement information for one or more plants via a signal received from a network location;
ascertaining current level information in the controlled environment;
comparing the current level information and the light requirement information; and,
adjusting the inputs to the controlled environment based on the light requirement information and current level information.

10. The method of claim 9, wherein determining light requirement information further comprises accessing a farming environment database via a bi-directional communication link.

11. The method of claim 9, wherein determining light requirement information further comprises accessing a farming environment website via a bi-directional communication link.

12. The method of claim 9, wherein determining light requirement information comprises determining a light quantity requirement.

13. The method of claim 9, wherein determining light requirement information comprises determining spectrum information by a signal received from the network location.

14. The method of claim 9, wherein adjusting comprises scheduling a luminere light source to be inactive during certain times of the day.

15. The method of claim 9, wherein adjusting comprises varying the spectrum of the light provided by the luminaire light source in the controlled farming environment.

16. An apparatus for optimizing plant growth in a controlled environment, the apparatus comprising:
a power source;
at least one processor; and
at least one memory including computer program code, the at least one memory and the computer program code configured to, with the at least one processor, cause the apparatus at least to:
determine light requirement information for one or more plants via a signal received from a network location;
ascertain current level information in the controlled environment; and,
adjust the inputs to the controlled environment based on the light requirement information and current level information.

17. The apparatus of claim 16, wherein the at least one memory and the computer program code are further configured to, with the at least one processor, cause the apparatus to access a farming environment database via a bi-directional communication link.

18. The apparatus of claim 16, wherein the at least one memory and the computer program code are further configured to, with the at least one processor, cause the apparatus to access a farming environment website via a bi-directional communication link.

19. The apparatus of claim 16, wherein the at least one memory and the computer program code are further configured to, with the at least one processor, cause the apparatus to, in said determining step, receive a light quantity requirement.

20. The apparatus of claim 16, wherein the at least one memory and the computer program code are further configured to, with the at least one processor, cause the apparatus to, in said determining step, receive spectrum information.

21. The apparatus of claim 16, wherein the at least one memory and the computer program code are further configured to, with the at least one processor, cause the apparatus to, in said adjusting step, schedule a light source to be inactive during certain times of the day.

22. The apparatus of claim 16, wherein the at least one memory and the computer program code are further configured to, with the at least one processor, cause the apparatus to, in said adjusting step, vary the spectrum of the light provided by a luminaire light source in the controlled farming environment.

23. The apparatus of claim 16, wherein the apparatus comprises a luminaire system.

24. The apparatus of claim 16, wherein the power source may comprise one or more renewable energy sources.
